(19) United States
(12) Patent Application Publication
(10) Pub. No.: US 2004/0101239 A1
(43) Pub. Date: May 27, 2004

(54) Chromatic-dispersion compensator

(76) Inventor: Michael Charles Parker, Colchester Essex (GB)

Correspondence Address: NIXON & VANDERHYE, PC, 1100 N GLEBE ROAD, 8TH FLOOR, ARLINGTON, VA, 22201-4714, US

(21) Appl. No.: 10/275,915

(22) PCT Filed: May 18, 2001
(86) PCT No.: PCT/GB01/02216

(30) Foreign Application Priority Data
May 19, 2000 (GB) 0012213.5

(51) Int. Cl. G02B 6/34

(52) U.S. Cl. 385/37

(57) ABSTRACT

A chromatic-dispersion compensator comprises: an input (3) for light of a plurality of wavelengths λᵢ; an output for output of the light; a plurality of chromalically dispersive elements (1, 2) situated between the input (3) and the output and each exhibiting a dispersion characteristic that varies approximately periodically with wavelength, the variation having a maximum ripple amplitude Aᵢ, each dispersive element (1, 2) exhibiting a dispersion characteristic of generally the same form as that of each other dispersive element (1, 2) but displaced in wavelength λ so that, over the operating bandwidth, the compensator exhibits a overall dispersion characteristic that has a variation with wavelength having a maximum ripple amplitude that is less than the sum of the respective maximum amplitudes Aᵢ.

This invention relates to the field of chromatic-dispersion compensators and in particular to chromatic-dispersion compensators for use in optical-fibre networks.

Wave-division-multiplexed (WDM) networks are important communications systems. As channel bit-rates have increased, the problem of temporal dispersion in dense WDM networks has become an increasingly important consideration in system design. There is a need for devices providing dynamically variable, low-ripple dispersion compensation over a large channel bandwidth and possibly over multiple channels.

Dynamic dispersion compensation has been demonstrated using, for example, fibre Bragg gratings (FBGs) [B. J. Eggleton et al., IEEE Photonics Tech. Lett. 11(7), 854 (1999)], a tunable etalon [L. D. Garrett, Proc. OFC 2000, Paper PD7, Baltimore, Md., March 2000], arrayed-waveguide gratings AWGs (see for example U.S. Pat. No. 5,002,350) and a device based on a Gires-Tournois interferometer [C. K. Madsen, G. Lenz, Proc. OFC 2000, Paper WF5, Baltimore, Md., March 2000]. Such devices can be essentially viewed as periodic time-sampled systems. A problem with such devices is that they suffer appreciable ripple in their dispersion-compensation characteristics.

An object of the invention is to provide a chromatic-dispersion compensator providing low-ripple dispersion compensation over a large channel bandwidth.

According to the invention there is provided a chromatic-dispersion compensator comprising: an input for light of a plurality of wavelengths; an output for output of the light; a plurality of chromatically dispersive elements (Q in number) situated between the input and the output and each exhibiting a dispersion characteristic that varies approximately periodically with wavelength, the variation having a maximum amplitude Aᵢ, each dispersive element exhibiting a dispersion characteristic of generally the same form as that of each other dispersive element but displaced in wavelength so that, over the operating bandwidth, the compensator exhibits a dispersion characteristic that has a variation with wavelength having a maximum amplitude that is less than the sum of the respective maximum amplitudes,

$${\sum }_{i = 1}^{Q} {A}_{i} .$$

Also according to the invention there is provided a chromatic-dispersion compensator comprising: an input for light of a plurality of wavelengths; an output for output of the light; a plurality of chromatically dispersive elements (Q in number) situated between the input and the output and each exhibiting a dispersion characteristic that varies with wavelength, the variation having an approximate period P, each dispersive element exhibiting a dispersion characteristic of substantially the same form as that of each other dispersive element but displaced in wavelength by a multiple of P so that the net dispersion of the compensator does not vary substantially with wavelength over an operating bandwidth.

Preferably, the dispersion characteristic is displaced by an amount such that the net dispersion of the compensator remains generally the same for all wavelengths over the operating bandwidth. Preferably, the wavelength displacement is by an approximately integer or non-integer multiple or sub-multiple of P.

The dispersion characteristics of each of the elements need only be of generally the same form; thus, they may be scaled in magnitude and/or wavelength. The number Q of dispersive elements required and the wavelength shifts required will depend upon those scalings; for example, two elements having dispersion characteristics of half the magnitude and the same period as the dispersion characteristic of a third element will both be displaced by P/2 relative to the third element (and displaced by zero relative to each other) in order to produce a low-ripple overall response. In general, the low-ripple response can be built up by an appropriate choice of magnitudes, periods and displacements for the dispersive elements in much the same way as a function can be built up by an appropriate choice of sine and cosine waves in Fourier analysis. Thus, concatenation of dispersive elements with non-identical dispersion characteristics and non-integer multiples of P/Q (including zero) is possible to effect suitable ripple-reduction in dispersion in the operating bandwidth.

Preferably, the approximate period of each element's dispersion characteristic is substantially the same.

Preferably, the wavelength displacement is by an integer multiple of a submultiple of P.

Preferably, the wavelength displacement is by an integer multiple of P/Q.

Preferably, each dispersive element exhibits a dispersion characteristic of substantially the same magnitude as that of each other dispersive element. Alternatively, the dispersion characteristics may be of the same form but of a different magnitude; for example, two elements each having dispersion characteristics of half the magnitude of a third could be used instead of two elements having dispersion characteristics of the same magnitude.

When the dispersion characteristics are of substantially the same magnitude and the approximate period of each element's dispersion characteristic is substantially the same, the wavelength displacement will be an integer multiple of P/Q, because Q elements will be needed to enable the net dispersion of the compensator to not vary substantially with wavelength over the operating bandwidth. In general, if the approximate period of each element's dispersion characteristic is substantially the same, the wavelength displacement will be an integer multiple of a submultiple of P, as stated above. For example, as explained above, if there are three elements (Q=3), two having dispersion characteristics of half the magnitude of the third, then the wavelength shift between the two will be zero and the wavelength shift between the third and the two will be P/2. If, on the other hand, there are two elements, each having dispersion characteristics of substantially the same magnitude, then the wavelength shift will again be P/2, which in this case equals P/Q.

Thus the dispersion characteristics of the individual dispersive elements are shifted relative to each other in such a way that the ripple on the dispersion characteristic is cancelled out by propagation through all of the elements of the compensator. For example, if there are two identical dispersive elements, their dispersion characteristics will be shifted by half a period relative to each other, so that troughs in the ripple of one element will cancel peaks in the ripple of the other element. Similarly, if there are three identical dispersive elements, a first element will have a particular periodic dispersion characteristic, a second element will have that same dispersion characteristic but shifted relative to the first by one third of the period, and a third will have that same dispersion characteristic but shifted relative to the first by two thirds of the period.

Of course, the dispersion characteristic of each element need not be periodic for all wavelengths; it is sufficient if the characteristic varies over a bandwidth that enables the net dispersion of the compensator to not vary substantially with wavelength over the operating bandwidth.

The wavelength displacement of each dispersive element may result from a linear phase shift imparted to adjacent different frequencies by a linear variation in the optical path lengths they traverse. The optical path lengths may be varied by, for example, thermal means, electrical means or mechanical means.

Preferably, the compensator comprises means for varying the dispersion of the compensator. Preferably, the dispersion may be actively varied in magnitude during use. Preferably, the means for varying the dispersion imparts a substantially parabolic phase shift to light passing through the compensator; such a phase shift may be achieved by a substantially parabolic variation in the optical path lengths traversed by the light; a substantially parabolic variation in path length will produce a substantially linear frequency chirp. The optical path lengths may be varied by, for example, thermal means, electrical means or mechanical means. Preferably, each of the dispersive elements comprises the means for varying the dispersion.

Preferably, the dispersive elements are chirped-grating devices; for example, they may be arrayed-waveguide gratings (AWGs). The dispersive elements may be fibre Bragg gratings (FBGs), which may be in optical communication with ports of an optical circulator. An AWG typically comprises first and second free-propagation regions (which may comprise, for example, silica for a silica-based AWG) and an array of waveguides interconnecting the first and second free-propagation regions, the optical path lengths of any two adjacent waveguides being different. In general, the optical path lengths of adjacent channels increase linearly across the waveguide, but alternatively the optical path lengths of adjacent channels may increase nonlinearly across the waveguide. Alternatively, the optical path lengths of adjacent channels may increase between some adjacent channels and decrease between other adjacent channels across the waveguide. The waveguides have entrance and exit apertures, which preferably lie on first and second arcs, respectively.

Adjacent AWGs will, in general, have adjacent free-propagation regions. The adjacent free-propagation regions may be connected to each other by waveguides, which may have entrance and exit apertures lying on arcs. Alternatively, there may be apertures at the boundary between adjacent free-propagation regions. An AWG having a single input port can be considered to be a 1×N de-multiplexer and a second such AWG, adjacent to the first, as a N×1 re-multiplexer. N represents the number of ports at the interface between the adjacent AWGs. In a single AWG, N will be the number of output ports from the device as a whole; for concatenated AWGs, however, N becomes a free design parameter, because the ports are internal to the device, and need not even correspond to actual apertures. Thus, N may be chosen to allow the compensator to be tailored for optimum insertion loss and physical size.

Theory developed by the inventor suggests that, if a single chirped-grating device has been designed for minimised dispersion-compensation ripple within the 3 dB-passband width Δλ_{3dB}, the product of absolute dispersion at the passband centre D(λ₀) and the square of the bandwidth is fundamentally limited so that

$$D ( {λ}_{0} ) \times {( Δ {λ}_{3 d B} )}^{2} \leq 18 ( \frac{{λ}_{0}^{2}}{c} ) , \qquad ( 1 )$$

where λ₀ is the wavelength at the passband centre and c is the speed of light. As bit-rates of communications systems increase, that limit becomes a significant constraint on the degree of dispersion compensation attainable. However, by concatenating devices having displaced dispersion profiles, according to the invention, the limit, which is for a single device, can be approached and possibly even exceeded, albeit at the expense of an increase in overall complexity.

Preferably an active trapezoidal region on the AWG imparts the wavelength displacement. Preferably, the means for varying the dispersion of the compensator is a symmetrical or non-symmetrical parabolic active region on the AWG.

Preferably, the chromatid-dispersion compensator further comprises an unchirped AWG arranged to re-multiplex wavelengths onto a single output line after light has passed through Q AWGs, where Q is odd.

Preferably, the compensator has one input channel. Alternatively, the compensator may have a plurality of input channels. Preferably, the compensator has one output channel. Alternatively, the compensator may have a plurality of output channels.

It is interesting to note that, in general, if the AWGs have identical dispersion characteristics and there is a single input channel, then there will usually be a single output channel if there are an even number of AWGs and multiple output channels if there are an odd number of AWGs.

Also according to the invention, there is provided a method of providing substantially uniform (i.e. low-ripple) dispersion compensation across an operating bandwidth, the method comprising: passing light of a plurality of wavelengths through a plurality of dispersive elements (Q in number) and dispersing the light in each dispersive element by an amount that varies approximately periodically with wavelength, the variation having a maximum amplitude Aᵢ, each dispersive element exhibiting a dispersion characteristic of generally the same form as that of each other dispersive element but displaced in wavelength so that, in passing through all of the elements, the light is dispersed by an amount that varies with wavelength, over the operating bandwidth, by at most an amplitude that is less than the sum of the respective maximum amplitudes,

$${\sum }_{i = 1}^{Q} {A}_{i} .$$

Also according to the invention, there is provided a method of providing substantially uniform dispersion compensation across an operating bandwidth, the method comprising: passing light of a plurality of wavelengths through a plurality of dispersive elements (Q in number) and dispersing the light in each dispersive element by an amount that varies with wavelength, the variation having a period P, each dispersive element exhibiting a dispersion characteristic of substantially the same form as that of each other dispersive element but displaced in wavelength by a multiple of P so that, in passing through all of the elements, the light is dispersed by an amount that does not vary substantially with wavelength over the said operating bandwidth.

An embodiment of the invention will now be described, by way of example only, with reference to the accompanying drawings, of which:

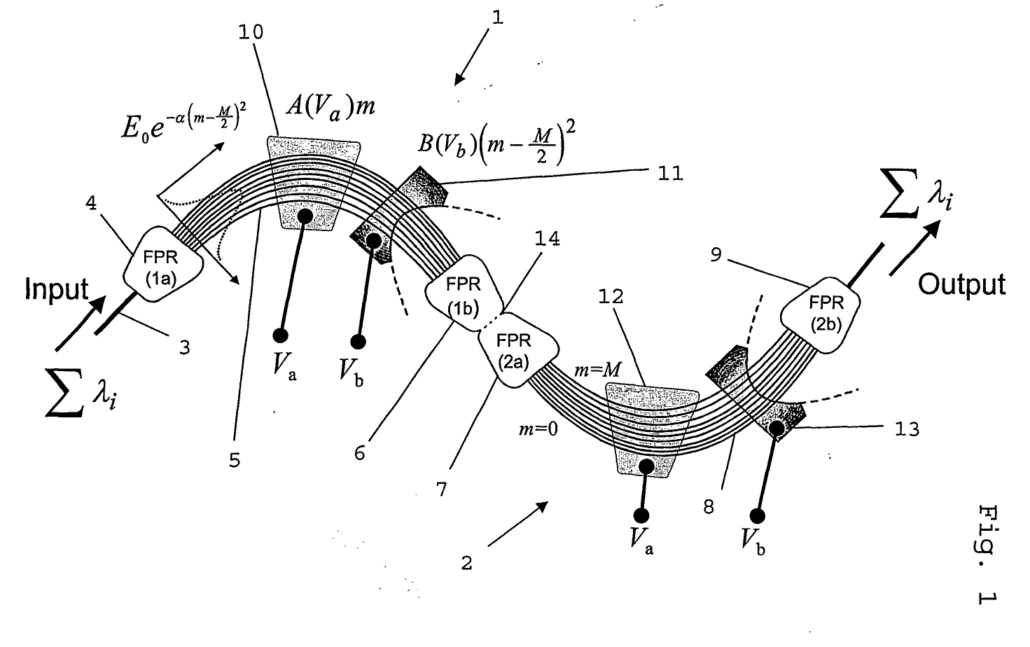

FIG. 1 is a schematic showing a dispersion compensator according to the invention, in the form of a pair of concatenated AWGs;

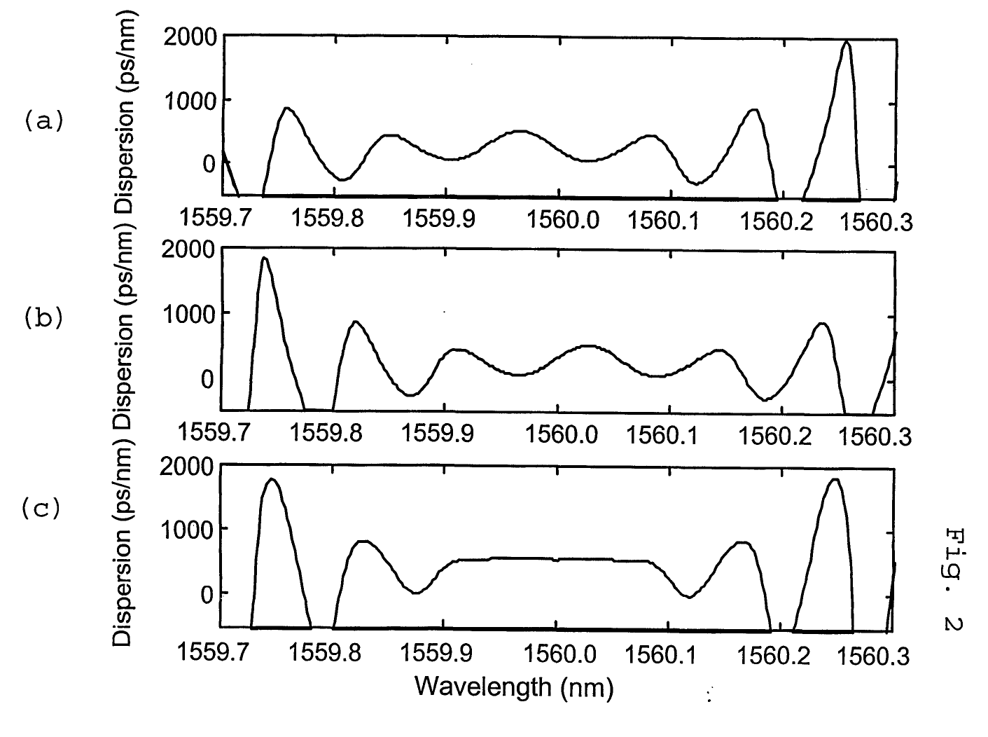

FIG. 2 shows: (a) & (b) simulated individual dispersion characteristics of each of the pair of concatenated AWGs of FIG. 1 and (c) simulated composite dispersion characteristic of the compensator of FIG. 1;

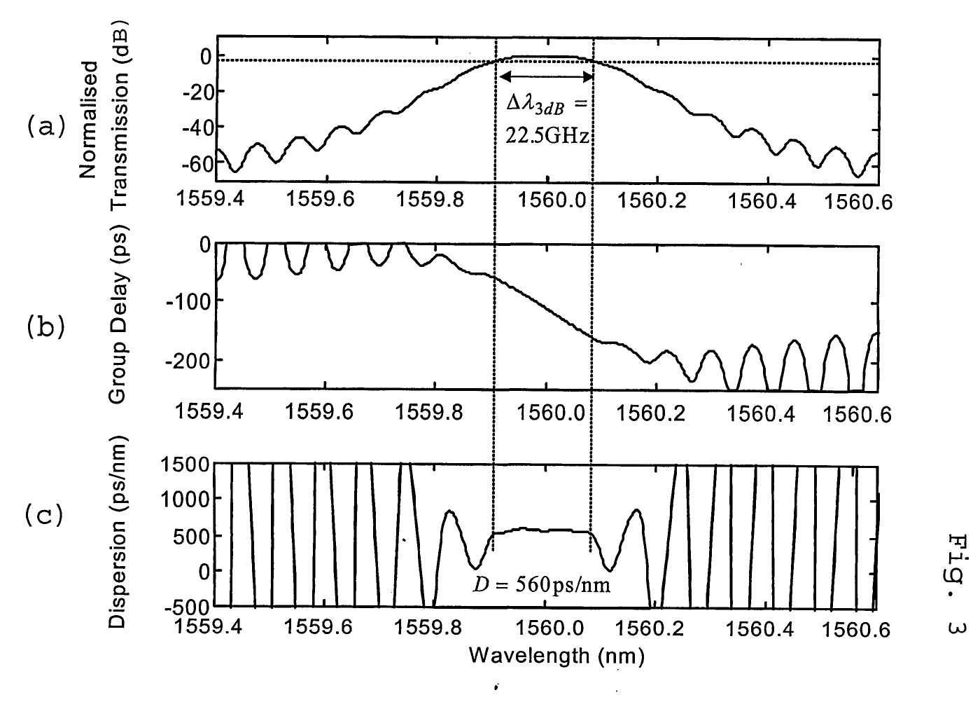

FIG. 3 shows simulated characteristics as functions of wavelength for the compensator of FIG. 1: (a) transmission |t(λ)|², (b) group delay τ_{d} and (c) dispersion characteristic

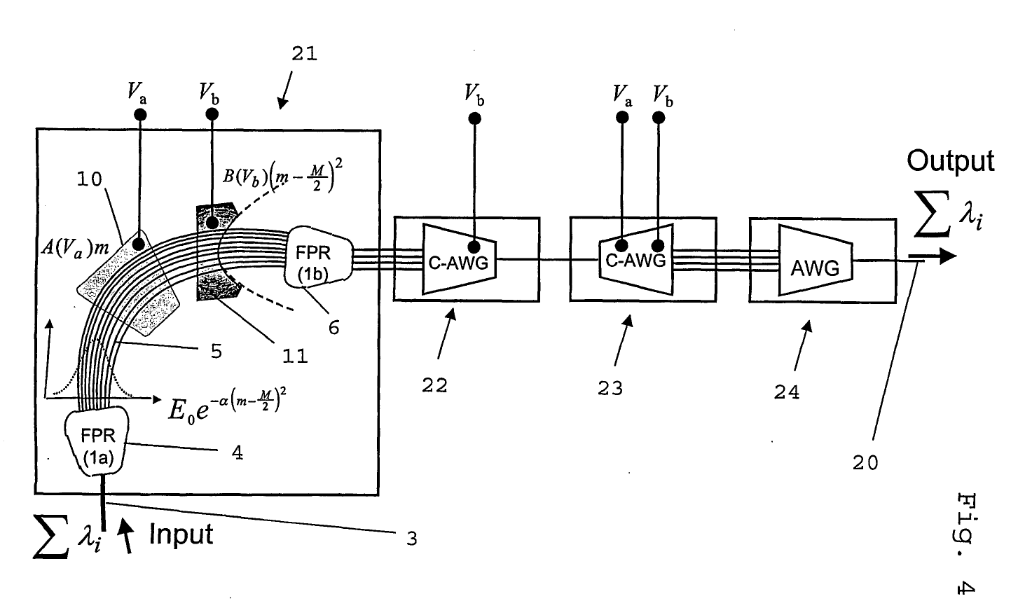

FIG. 4 is a schematic showing a second dispersion compensator according to the invention, in the form of a 3-phase compensator;

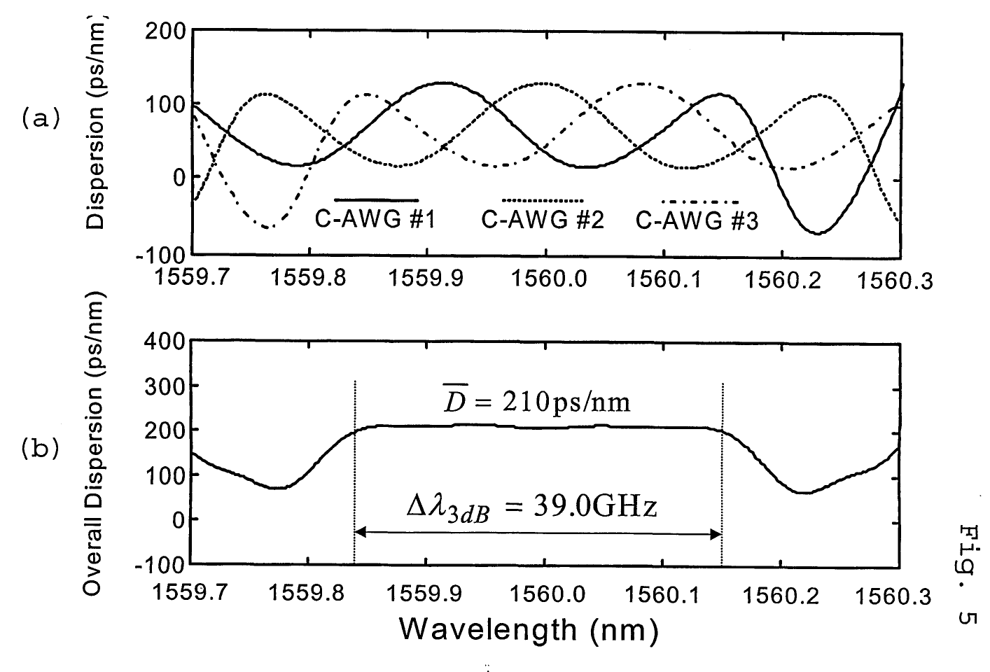

FIG. 5 shows: (a) simulated dispersion characteristics of each AWG in the compensator of FIG. 4 and (b) simulated composite dispersion characteristic of that compensator;

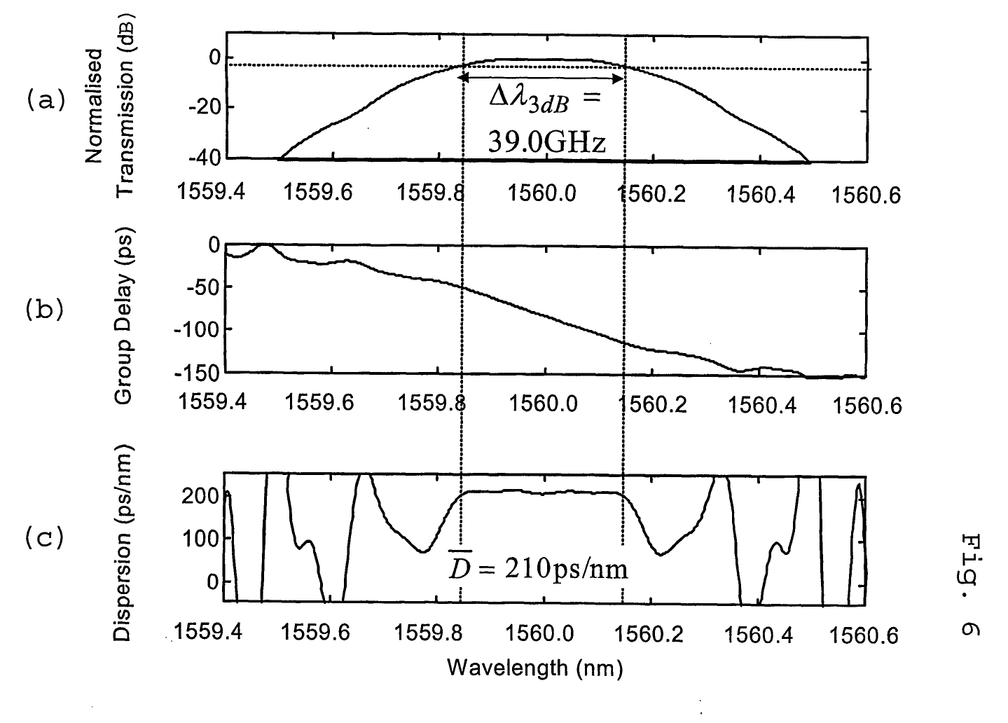

FIG. 6 shows: (a) the overall transmission of the compensator of FIG. 4, (b) the overall group-delay characteristic and (c) the overall dispersion characteristic;

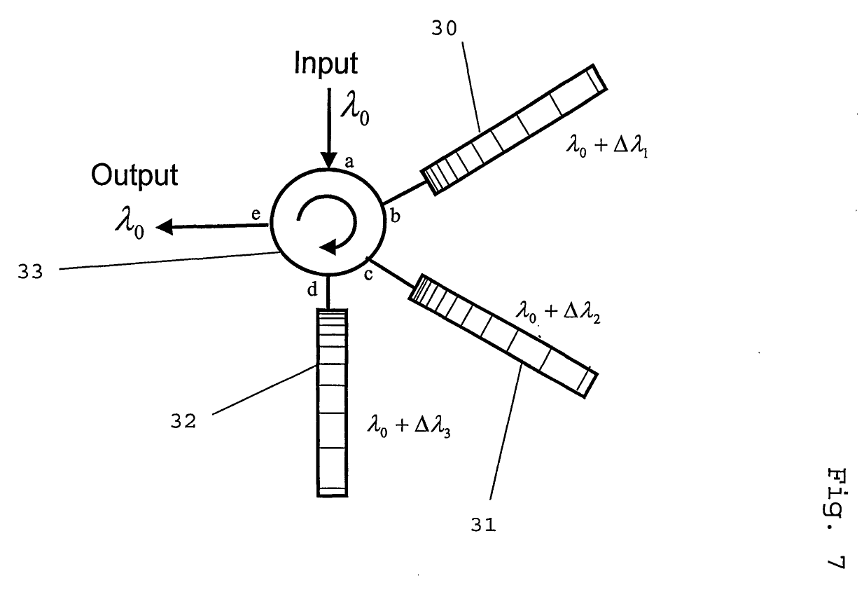

FIG. 7 is a schematic showing a third dispersion compensator according to the invention, in the form of a chirped fibre Bragg grating carousel based on a 5-port optical circulator, suitable for 3-phase low-ripple 2nd-order dispersion compensation.

The device shown in FIG. 1 consists of two AWGs 1 and 2, comprising: free-propagation regions 4 and 6, 7 and 9 (having arcuate boundaries, but depicted with linear boundaries for ease of representation); waveguide arrays 5 and 8; trapezoidal active regions 10 and 12; and parabolic active regions 11 and 13. The characteristics, such as free-spectral range (FSR) and number of arrayed waveguides, of AWGs 1, 2 are identical, except that the AWGs′ dispersion-compensation wavelength profiles are slightly detuned with respect to one another. (Of course, it is not a requirement of the invention that all characteristics of the dispersive elements be identical).

Operation of AWG 1 will now be described; in this embodiment, operation of AWG 2 is substantially identical, save for the detuning.

An AWG can be considered to be made up of two free propagation regions, one on the input side and one on the output side of the AWG, which are interconnected by an array of M+1 waveguiding channels, in sequence m=0 to M, with the channels having gradually increasing optical path lengths, so that the optical path length of the mth channel is greater than that of the (m−1)th channel. Light of wavelengths Σλᵢ is transmitted along optical fibre 3 and then propagates through free-propagation region 4 until it reaches waveguide array 5. Free-propagation regions 4 and 6 are sufficiently long as to allow Fraunhofer diffraction to occur, which means that Fourier optical concepts can be employed in analysis of the AWG [M. C. Parker et al., IEEE Journal of Special Topics in Quantum Electronics on Fibre-optic Passive Components, 5 (5), 1379 (1999)] . Waveguide array 5 can be regarded as a Fourier plane within the optical system.

The input light is distributed with a Gaussian intensity profile

$${E}_{0} exp [ - {α ( m - \frac{M}{m} )}^{2} ]$$

across the waveguides of array 5. Array 5 provides an overall complex apodisation function; that is, it affects both the phase and amplitude of the input light. Parabolic active region 11 is a phase-control means that can be used to produce a programmable near- or sub-parabolic phase profile in the array 5 (which is the Fourier plane); that results in a quasi-elliptical filter response (i.e., it results in a quasi-linear chirp), exhibiting ripple in the device response spectrum.

Active trapezoidal region 10 is a phase-control means used to impose across the array a programmable linear phase profile. The Fourier transform of that imposed profile is a wavelength shift, which manifests itself at plane 14 after propagation away from the Fourier plane through free-propagation region 6.

Each of active regions 10, 11, 12 and 13 may for example be a layer of hydrogenated amorphous silicon (α-Si:H) for an AWG based on silicon technology or alternatively a thermo-optic region for an AWG based on silica. Alternatively, the regions may be embodied for example in the form of electrodes in an AWG based on indium phosphide or lithium niobate technology. It can be assumed that the phase shift imparted on a given waveguide will be proportional to the length of the channel segment over which the phase control means extends; hence, a parabolic phase shift is imparted by an active region having a length varying parabolically across the array 5, 8 and a linear phase shift is imparted by an active region having a length varying linearly across the array 5, 8 (for example, a trapezoidal region).

AWG 1 can be considered to be a 1×N de-multiplexer and AWG 2 as a N×1 re-multiplexer. By designing the free spectral range of the AWGs 1,2 such that FSR=N×100 GHz, the device shown in FIG. 1 operates as an in-line variable dispersion compensator on all 100 GHz-ITU-grid channels. N represents the number of ports at the interface between AWG 1 and AWG 2 and so is a free design parameter, such that the overall device can be tailored for optimum insertion loss and physical size (which tends to scale as approximately 1/FSR). The anti-symmetric trapezoidal regions 10,12 on the Fourier-planes of their respective AWGs 1,2 are spatially arranged to cause spectral detuning in opposite directions, so that the overall (average) centre wavelength of the device remains constant. The parabolic regions 11,13, being spatially symmetric, cause no device detuning. For the Nth output port of a single AWG, the spectral transmission response is given approximately by

$${t}_{n} ( λ ) \approx \frac{- j \sqrt{π r} W}{λ R} {\sum }_{m = 0}^{M} exp \{ j \frac{2 π n Δ1}{λ} [ 1 + A ( {V}_{a} ) - \frac{{x}_{N} W}{R Δ1} ] m + ( j \frac{2 π Δ1 B ( {V}_{b} )}{λ} - α ) {( m - \frac{M}{2} )}^{2} \} \qquad ( 2 )$$

where n is the refractive index, Δl the incremental path length difference between neighbouring waveguides in an equivalent device having no active regions, r is the waveguide mode spot size, R is the length of the free propagation region (FPR), W is the centre-to-centre distance between neighbouring waveguides at the FPR entrance, M+1 is the number of waveguides in the array of each AWG, x_{N} is the distance of the Nth output port from the optical axis. The voltage-dependent coefficient A(Vₐ) tunes (in trapezoidal regions 10, 12) the centre wavelength of light at the Nth output port λ_{0,n} such that

$${λ}_{0 , N} \approx \sqrt{F S R n Δ1} [ 1 + A ( {V}_{a} ) - \frac{{x}_{N} W}{R Δ1} ] \qquad ( 3 )$$

By considering an AWG as a planar 4f lens-relay system, Fourier-Fresnel transform theory can be employed [M. C. Parker et al., IEEE Journal of Special Topics in Quantum Electronics on Fibre-optic Passive Components, 5(5), 1379 (1999)] and equation (2) rewritten as a series of Fresnel integrals

$$t ( λ ) \approx - \frac{r W}{λ R} \frac{π}{\sqrt{2}} \frac{M}{2 b} \{ {C}_{1} ( a + b ) - {C}_{1} ( a - b ) + j {S}_{1} ( a + b ) - j {S}_{1} ( a - b ) ) \} {ⅇ}^{jφ} \qquad ( 4 )$$

C₁ and S₁ are the Fresnel cosine and sine integrals of the first kind, and the normalised parameters a, b and (as defined in the aforementioned paper are given by

$$\begin{matrix}a = \frac{π ( {λ}_{0} - λ )}{2 FSR \sqrt{\frac{π {λ}_{0}}{2 FSR} B ( {V}_{b} ) + j \frac{α}{4}}} & ( 5 a ) \\ b = M \sqrt{\frac{π {λ}_{0}}{2 FSR} B ( {V}_{b} ) + j \frac{α}{4}} & ( 5 b ) \\ φ = \frac{M π ( {λ}_{0} - λ )}{FSR} - \frac{{{π}^{2} ( {λ}_{0} - λ )}^{2}}{4 {FSR}^{2} ( \frac{π {λ}_{0}}{2 FSR} B ( {V}_{b} ) + j \frac{α}{4} )} & ( 5 c )\end{matrix}$$

with α being the parameter associated with the assumed Gaussian electric-field amplitude profile across the AWGs, as shown in FIG. 1. The voltage-dependent coefficient B(V_{b}) acts only to control the degree of chirping and hence the strength of the dispersion compensation. Using equation (4), the dispersion characteristic at passband centre wavelength λ₀ is analytically given by

$$D ( {λ}_{0} ) = \frac{1}{c} {( \frac{M {λ}_{0}}{2 FSR} )}^{2} Re \{ \frac{π}{{b}^{2}} - \frac{\sqrt{2 π}}{b} ( \frac{C [ b ] cos {b}^{2} + S [ b ] sin {b}^{2}}{{C}^{2} [ b ] + {S}^{2} [ b ]} ) \} \qquad ( 6 )$$

For small values of B(V_{b}), D is found to vary linearly with B (which is an implicit function of voltage V_{b}) and is approximately given by

$$\begin{matrix}D ( {λ}_{0} ) \approx \frac{1}{c} {( \frac{M {λ}_{0}}{2 FSR} )}^{2} \frac{8 π}{45} [ 1 - \frac{12 {α}^{2}}{315} - O ( {α}^{4} ) ] F & ( 7 ) \\ where F = \frac{π {M}^{2} {λ}_{0}}{2 F S R} B & ( 8 )\end{matrix}$$

so that both positive and negative dispersion can be attained, for positive and negative B respectively. Normalised chirp parameter F is related linearly to B, but is essentially independent of the AWG parameters such as FSR, number of arrayed waveguides M+1 and wavelength of operation.

Computer simulations of the performance of the device shown in FIG. 1 have been carried out. Each AWG 1,2 has a FSR=9.6 nm (that is, 12×100 GHz), with M=128 waveguides in each array. Hence N=12 apertures are required in the interface between the AWGs, to achieve dispersion compensation for all channels spaced by 100 GHz. The product of the two individual AWG transfer functions gives the overall device response. FIG. 2 shows the dispersion characteristics of the individual AWGs 1, 2 of the cascade, each chirped to achieve maximum dispersion compensation (F=4.4) and with Gaussian parameter

$${α ( \frac{M}{2} )}^{2} = 0.8 .$$

Apparent is the large degree of ripple, varying from almost zero to 560 ps/nm across the 3 dB passband width Δλ_{3dB}=22.5 GHZ. However, the ripple is spectrally periodic in nature, of period approximately equal to FSR/M, so that detuning of the two AWGs with respect to each other by half a period causes the ripples to cancel. The resulting composite dispersion compensation characteristic is shown in FIG. 2(c), with a uniform, virtually ripple-free dispersion of 560 ps/nm over an operating bandwidth of approximately 22.5 GHz. FIG. 3 shows the associated amplitude response and group-delay characteristic of the adaptive dispersion compensation cascaded device. By employing the device as a fine-tuning dispersion compensation element, in conjunction with a fixed dispersion compensation device (e.g. dispersion compensation fibre), itself compensating for a fixed length of 100 km of single-mode fibre, the resulting adaptive dispersion compensation unit can be used to compensate for between 65 and 135 km of single-mode fibre, assuming +16 ps/nm/km dispersion.

Thus, virtually ripple-free dispersion compensation of up to +560 ps/nm is possible, for bit rates up to 20 Gb/s, for all channels on a 100 GHz grid. Such a device can be usefully employed in long-haul submarine or terrestrial systems, where automatic dispersion correction is a desirable feature.

FIG. 4 shows a concatenated AWG configuration for 3-phase ripple-reduction in the dispersion characteristic, suitable for adaptive dispersion compensation (DC) at 40 Gb/s. The device comprises three chirped-AWGs (C-AWGs) 21, 22, 23, with identical characteristics, such as free-spectral range (FSR), number of arrayed-waveguides, etc., but optimally detuned with respect to one another.

Pairs of C-AWGs can be considered as de-multiplexing and re-multiplexing devices respectively. However, for an odd number of C-AWGs, an additional non-chirped AWG 24 is required to re-multiplex the wavelengths onto a single line 20. Voltages Vₐ and V_{b} are applied to trapezoidal regions 10 and parabolic regions 11 (respectively) of AWGs 21 and 23, but the central C-AWG 22 does not require an active trapezoidal region 10 on its Fourier-plane, since the neighbouring C-AWGs 21, 23 can be detuned with respect to the central C-AWG. Each C-AWG has a FSR=19.2 nm (≡24×100 GHz), with M=128 waveguides in each array. Hence N-24 apertures are required in the interfaces between the C-AWG re-multiplexing pairs, to achieve DC for all channels spaced by 100 GHz. The dispersion characteristics of the individual C-AWGs (FIG. 5(a)) and the overall device (FIG. 5(b)) show how the 3-phase detuning can produce a smooth overall dispersion characteristic. Each C-AWG 21, 22, 23 has been chirped to achieve maximum dispersion compensation, with Gaussian parameter

$${α ( \frac{M}{2} )}^{2} = 0.8 .$$

Ripple for each individual C-AWG varies from approximately zero to 135 ps/nm across the 3 dB passband width. However, the overall smoothed 3-phase dispersion has an average of 210 ps/nm, with the ripple reduced to ±7.4 ps/nm. FIG. 6 shows the overall device transmission (FIG. 6(a)), group delay (FIG. 6(b)) and dispersion characteristics (FIG. 6(c)). The 3 dB-bandwidth is 39.0 GHz, making it suitable for 40 Gb/s dispersion compensation for all channels on a 100 GHz grid.

The AWG cascade of FIG. 4 is equivalent to a carousel of fibre Bragg gratings 30, 31, 32 (operating in a reflective mode) around a 5-port optical circulator 33 (FIG. 7). The equivalent carousel of FBGs for FIG. 1 would consist of a 4-port optical circulator and 2 FBGs respectively positioned at the appropriate ports (b and c). In general, for a dispersion compensator device consisting of Q chirped FBGs (dispersive elements), a “Q+20”-port optical circulator is required, since two extra ports for the input and output waveguides are also required. (It should be noted that higher-port-count optical circulators are easily made by appropriately concatenating multiple lower-port-count optical circulators). Since FBGs tend to operate only for a single channel, a final “remultiplexing” FBG (equivalent to the 4th (unchirped) AWG 24 of FIG. 4) is not required. In the embodiment of FIG. 7, linearly-chirped FBGs are employed, with the FBGs detuned with respect to each other by appropriate amounts Δλ₁, Δλ₂, Δλ₃, (equivalent to the AWG detunings controlled by the parameter A(Vₐ) of equation 3, associated with the AWG embodiment) from the centre wavelength o, to achieve the appropriate reduced-ripple 2nd-order dispersion characteristic over the passband range of interest. However, FBG 31 at port c does not necessarily need to be detuned (i.e. similarly for AWG 22 in FIG. 4), such that Δλ₂=0, and Δλ₁=−Δλ3. We note that since AWGs tend to operate at high grating orders, the small free-spectral range (FSR) allows multiple wavelengths to be dispersion compensated. This would imply that long period FBGs operating at similarly high-orders may also be suitable for multiple wavelength use (with an appropriate remultiplexing non-chirped FBG required for odd-phase ripple reduction).

It will be appreciated that various modifications and variations can be made to the designs described above.

1. A chromatic-dispersion compensator comprising: an input for light of a plurality of wavelengths; an output for output of the light; a plurality of chromatically dispersive elements (Q in number) situated between the input and the output and each exhibiting a dispersion characteristic that varies approximately periodically with wavelength, the variation having a maximum amplitude Aᵢ, each dispersive element exhibiting a dispersion characteristic of generally the same form as that of each other dispersive element but displaced in wavelength so that, over the operating bandwidth, the compensator exhibits a dispersion characteristic that has a variation with wavelength having a maximum amplitude that is less than the sum of the respective maximum amplitudes,
$${\sum }_{i = 1}^{Q} {A}_{i} .$$

2. A chromatic-dispersion compensator as claimed in claim 1, in which each dispersive element exhibits a dispersion characteristic of substantially the same magnitude as that of each other dispersive element.

3. A chromatic-dispersion compensator as claimed in any preceding claim, in which the approximate period P of each element's dispersion characteristic is substantially the same.

4. A chromatic-dispersion compensator as claimed in any preceding claim, in which the wavelength displacement is by an integer multiple of a submultiple of P.

5. A chromatic-dispersion compensator as claimed in claim 4, in which the wavelength displacement is by an integer multiple of P/Q.

6. A chromatic-dispersion compensator as claimed in any preceding claim, in which the wavelength displacement in the elements results from an appropriate linear phase shift imparted to adjacent different frequencies.

7. A chromatic-dispersion compensator as claimed in any preceding claim, in which the linear phase shift is imparted by a linear variation in the optical path lengths that the frequencies traverse.

8. A chromatic-dispersion compensator as claimed in any preceding claim, comprising means for varying the dispersion of the compensator.

9. A chromatic-dispersion compensator as claimed in claim 8, in which the means for varying the dispersion imparts a substantially parabolic phase shift to light passing through the compensator.

10. A chromatic-dispersion compensator as claimed in claim 8 or claim 9, in which each of the dispersive elements comprises the means for varying the dispersion.

11. A chromatic-dispersion compensator as claimed in any preceding claim, in which the dispersive elements are chirped-grating devices.

12. A chromatic-dispersion compensator as claimed in claim 11, in which the dispersive elements are fibre Bragg gratings.

13. A chromatic-dispersion compensator as claimed in claim 12, in which the fibre Bragg gratings are in optical communication with ports of an optical circulator.

14. A chromatic-dispersion compensator as claimed in claim 11, in which the dispersive elements are arrayed-waveguide gratings (AWGs).

15. A chromatic-dispersion compensator as claimed in claim 14, in which adjacent AWGs will have adjacent free-propagation regions that are connected to each other by waveguides.

16. A chromatic-dispersion compensator as claimed in claim 15, in which the waveguides have entrance and exit apertures lying on arcs.

17. A chromatic-dispersion compensator as claimed in claim 15, in which there are apertures at the boundary between adjacent free-propagation regions.

18. A chromatic-dispersion compensator as claimed in any of claims 14 to 17, in which an active trapezoidal region on the AWG imparts the wavelength displacement.

19. A chromatic-dispersion compensator as claimed in any of claims 14 to 18 as dependent on claim 8, in which the means for varying the dispersion of the compensator is a parabolic active region on the AWG.

20. A chromatic-dispersion compensator as claimed in any of claims 14 to 19, further comprising an unchirped AWG arranged to re-multiplex wavelengths onto a single output line after light has passed through Q AWGs, where Q is odd.

21. A chromatic-dispersion compensator as claimed in any preceding claim, comprising one input channel.

22. A chromatic-dispersion compensator as claimed in any preceding claim, comprising one output channel.

23. A chromatic-dispersion compensator as claimed in any preceding claim, comprising a plurality of input channels.

24. A chromatic-dispersion compensator as claimed in any preceding claim, comprising a plurality of output channels.

25. A method of providing low-ripple dispersion compensation across an operating bandwidth, the method comprising: passing light of a plurality of wavelengths through a plurality of dispersive elements (Q in number) and dispersing the light in each dispersive element by an amount that varies approximately periodically with wavelength, the variation having a maximum amplitude Aᵢ, each dispersive element exhibiting a dispersion characteristic of generally the same form as that of each other dispersive element but displaced in wavelength so that, in passing through all of the elements, the light is dispersed by an amount that varies with wavelength, over the operating bandwidth, by at most an amplitude that is less than the sum of the respective maximum amplitudes,
$${\sum }_{i = 1}^{Q} {A}_{i} .$$
